(19) United States
(12) Patent Application Publication
(10) Pub. No.: US 2026/0113330 A1
(43) Pub. Date: Apr. 23, 2026

(54) MULTI-TENANT ACCESS TO CLUSTER RESOURCES

(71) Applicant: Oracle International Corporation, Redwood Shores, CA (US)

(72) Inventors: Olgierd Stanislaw Pieczul, Dublin (IE); Abhinav Mishra, Livermore, CA (US); Karl Halley Heiss, Raleigh, NC (US); Joshua Aaron Horwitz, Centreville, VA (US)

(73) Assignee: Oracle International Corporation, Redwood Shores, CA (US)

(21) Appl. No.: 18/922,002

(22) Filed: Oct. 21, 2024

(51) Int. Cl. H04L 9/40

(52) U.S. Cl. CPC H04L 63/105

(57) ABSTRACT

Techniques may include receiving a request from a tenant to perform an operation with respect to a containerized application. The containerized application can be one of a plurality of containerized applications that are executing on the one or more second computing devices, and where workloads are assigned to the containerized applications by a service provider computing device. In addition, the techniques may include obtaining an identity for the request. The techniques may include providing the identity and the request to a resource manager computing device that is configured to query an access management computing device to determine whether the identity is permitted to perform the operation. The operation may include a change to a parameter of the one or more second computing devices. The techniques may include receiving a response to the request. The response can indicate whether the identity is permitted to perform the operation.

### BACKGROUND

Cluster architectures can allow for scalable deployment of computing resources. The cluster can allocate containerized workloads to nodes withing the cluster, and the cluster can provide the node with the appropriate resources for executing the workload. Permission to control the resources may be set at a cluster level, and this may mean that a cluster’s resources are accessible by all of a cluster’s tenants. Accordingly, improvements to managing access to resources in a multi-tenant cluster architecture are desirable.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, techniques may include receiving, at a service provider computing device of a cloud computing system, a request from a tenant to perform an operation with respect to a containerized application that is executing on one or more second computing devices of the cloud computing system. The containerized application can be one of a plurality of containerized applications that are executing on the one or more second computing devices, and workloads of the plurality of containerized applications can be assigned to the one or more second computing devices by the service provider computing device. The techniques may also include obtaining, by the service provider computing device, an identity associated with the request. The techniques may furthermore include providing, by the service provider computing device and to a resource manager computing device of the cloud computing system, the identity and the request to perform the operation with respect to the containerized application. The resource manager computing device can be configured to query an access management computing device to determine whether the identity is associated with permission to instruct the resource manager computing device to perform the operation with respect to the containerized application. The techniques may in addition include receiving, by the service provider computing device and from the resource manager computing device, a response to the request to perform the operation with respect to the containerized application, where the response indicates whether the resource manager computing device is permitted to perform the operation with respect to the containerized application. Other embodiments of these techniques include corresponding methods computer systems, apparatus, and computer programs recorded on one or more non-transitory computer storage devices, each configured to perform the actions of the techniques.

Implementations may include one or more of the following features. Techniques where obtaining the identity associated with the request may include: identifying, by the service provider computing device, metadata of the request, where the metadata may include information identifying one or more of the tenant, the containerized application, the operation with respect to the containerized application, the one or more second computing devices, and the plurality of containerized applications; providing, by the service provider computing device, the metadata to an identity engine, where the identity engine is configured to compare the metadata to one or more permissions of the one or more second computing devices of the cloud computing system, where the one or more permissions specify the identity; and receiving, by the service provider computing device, information identifying the identity from the identity engine. Techniques where obtaining the identity associated with the request may include: checking, by the service provider computing device, an application flag of the request; and assigning, by the service provider computing device, the identity based at least in part on the application flag. Techniques where the tenant is one of a plurality of tenants with permission to perform operations with respect to at least one of the plurality of containerized applications that are executing on the one or more second computing devices. The techniques may include: instructing, by the service provider computing device, the one or more second computing devices to execute a workload of the containerized application. Techniques where the operation with respect to the containerized application may include a change to a parameter of the one or more second computing devices. Techniques where parameters of the one or more second computing devices are assigned by the resource manager computing device. Implementations of the described techniques may include hardware, a method or process, or a non-transitory computer tangible medium.

### BRIEF DESCRIPTION OF THE DRAWINGS

FIG. 1 shows a simplified diagram of a cluster architecture according to at least one embodiment.

FIG. 2 shows a simplified diagram of a technique for providing a resource to a cluster according to at least one embodiment.

FIG. 3 shows a simplified diagram of an architecture that includes an identity engine according to various embodiments.

FIG. 4 is a block diagram illustrating an example method for determining resource permissions, in accordance with at least one embodiment.

FIG. 5 shows a simplified diagram of a computer according to at least one embodiment.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A cloud service provider may use a cluster computing architecture to process customer workloads. A cluster computing architecture, such as Kubernetes, simplifies assigning workloads because the workloads can be assigned to multiple devices through a single endpoint (e.g., a cluster controller or controller). In a cluster computing architecture, computing devices are organized into clusters that are managed by a control plane computing device (e.g., the cluster controller). Instead of assigning each workload to a particular computing device, the workloads can be assigned to the cluster’s computing devices by the controller. Each computing device in the cluster may have a different shape (e.g., available computing resources), and the controller can determine which workload is best suited for a particular computing device. For example, the controller may assign a computationally demanding workload to the computing device with the largest number of central processing units (CPUs).

The cloud service provider may support a multi-tenancy cluster computing architecture in some embodiments. Multi-tenancy may refer to an architecture where multiple customers of the cloud service provider (e.g., tenants) are permitted to assign workloads to a cluster (e.g., via the controller). However, the tenants may not directly allocate workloads to the cluster’s computing devices and a computing device within the cluster may only execute workloads from one tenant at a time.

A tenant within a multi-tenant cluster architecture may retain separate computing resources that are not shared by the other cluster tenants. For example, the tenant may control a storage media that can be attached to different devices in the cloud service provider’s system. In a multi-tenant cluster architecture, the controller may need access to a tenant’s separate computing resources in order to execute the tenant’s workloads. For example, a tenant’s storage media may need to be attached to a cluster computing device or a network in order to access stored data for a workload. In addition, the cluster computing devices can access other cloud resources and make them available to the workload running in the cluster. For example, any of the computing devices associated with a cluster may fetch secrets managed by an access manager and make them available to specific workloads.

In this case, all the separate computing resources, corresponding to different tenants and workloads, may be managed by a single shared cluster controller. Tenants may grant access to their respective cloud resources to single shared cluster actor so that the resources can be used to perform workloads. This in turn, may result in a security problem called the “confused deputy.” As the cluster has access to all resources of all tenants, this access can be exploited by individual tenants. A malicious tenant may attempt to attach or access cloud resource of another tenant by referring to the other tenant’s resource in the malicious tenant’s workload. A controller may fulfill that request because the controller has equal access to all cloud resources associated with tenants that share the cluster, and the controller (e.g., the confused deputy) may not be able to differentiate between a particular tenant’s resources and the cluster’s common resources.

For example, a single cluster hosts two workloads of two different tenants, A and B. Tenant A would like to attach storage devices to a host that is executing their workloads. In order to attach the device, tenant A may grant access to a collection of storage cloud resources to the cluster. Tenant B can attempt to exploit the multi-tenant permissions, and tenant B references tenant A’a block device in their workload. In response, the controller can access the storage device and, because the controller already has the required access from tenant A, the controller succeeds in attaching the device to a host that is executing Tenant B’s workload.

Access to resources in a multi-tenant cloud architecture can be managed by techniques that allow a controller to assume different workload-specific identities when performing cloud resource management operations (e.g., attaching a storage device to a host). The cloud service provider can specify groups of cloud resources that are available to all of the cluster’s tenants and groups of cloud resources that are available to perform particular workloads. The tenants may configure these groups by providing instructions to the cloud service provider’s control plane. Permission to control these cloud resources can be associated with different identities, and a tenant may be able to control a particular workload specific identity that is separate from a cluster identity. For example, the controller can assume a cluster identity when performing an operation on cloud resources that are shared by all of the cluster’s tenants, and the controller can assume a workload identity when performing an operation on a particular tenant’s cloud resources. A tenant may be associated with one or more workload identity and the customer can configure the cloud service provider’s system to associate resources with specific workload identities.

The controller, when performing cloud resource management operations can consult the cloud service provider’s system and assumes a corresponding identity for a desired resource. For example, an identify engine in the cloud service provider’s control plane may manage a mapping of identities to resources. The identity engine may take different forms. For example, the identity engine can consult the cluster-wide configuration to determine the mapping of identities to resources. Such configuration could specify rules for given resources or workloads within a cluster. In some embodiments, the configuration can be a direct, static mapping of which operations performed by the controller can be performed with which type of identity. For example, the controller can be modified to perform storage-related cloud operations using common cluster identity while assuming workload-specific identity for network-related operations.

In a different embodiment, the identity can be provided by an identity engine that is an active component that is provided by cloud vendor (e.g., in a form of webhook) and the identity engine can allow a tenant to perform custom logic. In such an embodiment, cluster tenants can choose which operations should be performed using what type of identity through instructions to the identity engine. Management of cluster workloads can be done in declarative way, by tenants creating specific cluster objects (such as Load Balancer) in the cluster control plane. These objects can be a declaration of expected state of the cluster resources represented by each object. The controller can subsequently examine the objects, and, if the expected and actual state different, the cluster controller can perform operations to reconcile the expected state with the actual state. Cluster objects can allow for metadata that can provide context to the cluster controllers. This metadata can be used to control the identity used by the cluster controller. When creating objects that, in turn, require cluster controllers to access other cloud resources, tenants may annotate the objects’ metadata to state what type of identity should be used by the cluster to perform that operation.

This cluster identity mechanism may have varying level of flexibility or configuration by the cluster administrator. For example, a cluster controller may always use specific service account name (e.g., a service identity) when assuming identity of the workload and the tenant is only offered with binary flag to use the identity or not. Tenants may be offered the option to choose the service account name in some embodiments. The controller may also limit the set or pattern of account names that could be used or ensure that they exist in the same namespace as the objects that they are referred in. Finally, the cloud service provider may limit the usage of this cluster identity mechanism only to specific tenants or only to specific operations.

In some embodiments, the cluster controller can perform more dynamic control of the access to cluster resources based on multiple criteria. For example, controller may decide to perform operations on cloud resources with various types of identities based on properties of the specific workload. For example, the controller may use different identity for network operations related to workload hosted on one type of the node (e.g., direct customer-controlled node) and different on another (e.g., serverless nodes provisioned by the cluster).

In an illustrative example, tenant A attempts to attach a storage volume to a node within a cluster. Tenant A is part of a multi-tenant cluster with tenant B and tenant C, and the storage volume is one of tenant B’s resources that is not shared by the cluster. The request from tenant A to attach the storage volume is sent to an access manager with a workload specific identity that is associated with tenant A. The access manager checks the workload specific identity against the permissions for the storage volume, and the manager rejects the request because the identity does not have permission to perform operations with respect to the storage volume.

A second request to attach the storage volume is received at the access manager, and this request, which is received from tenant B, includes a workload specific identity that is associated with tenant B. The access manager verifies that the identity is associated with permission to perform operations using the storage volume and the access manager instructs a resource manager that the request is authorized. In response to this approval, the resource manager causes the storage volume to be attached to the cluster identified in the second request.

The dynamic controller identities described herein offer technical improvements over existing techniques. Assigning a dynamic controller identity, such as a workload specific identity, can allow for a multi-tenant cluster architecture that allows a tenant to assign workloads to the cluster without exposing the tenant’s resources to the other tenants. The disclosed techniques therefore provide a technical improvement by allowing for configurable multi-tenant clusters that do not expose an individual tenant’s resources to multiple tenants. This provides a technical benefit of improving the functioning of a computer system because computing resources can be shared by multiple tenants without exposing the individual tenant’s data to the remaining tenants. If the cluster could not share multiple tenants, then

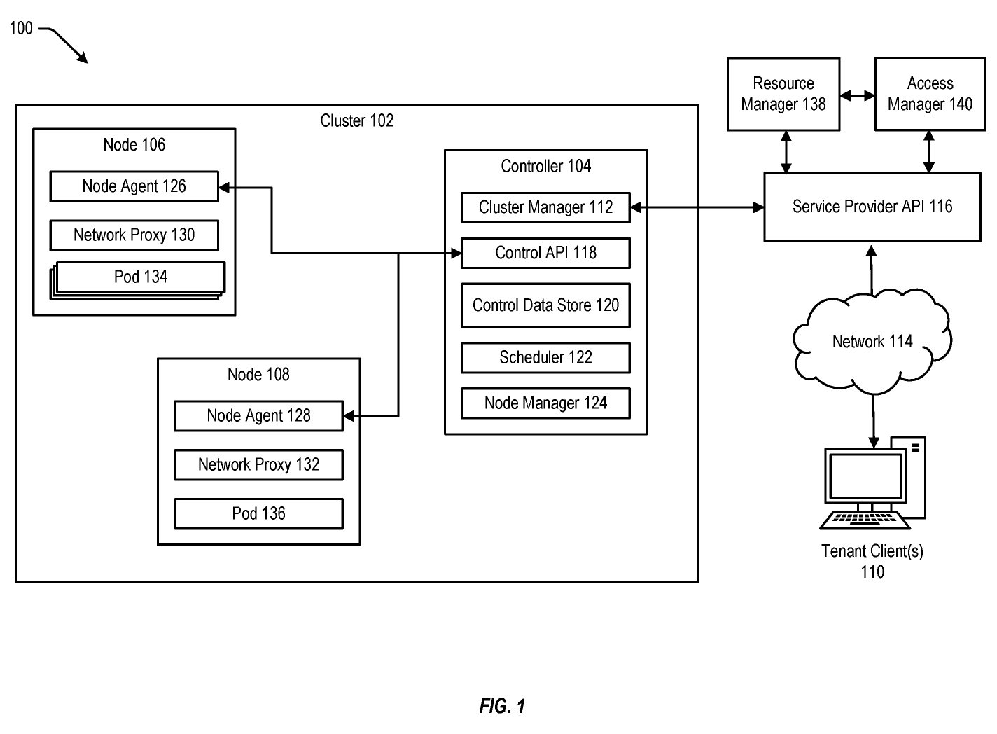

FIG. 1 shows a simplified diagram 100 of a cluster architecture according to at least one embodiment. Cluster 102 can include a controller 104 and one or more nodes 106-108. The controller 104 and the one or more nodes 106-108 are computing devices, and, while two nodes are shown in diagram 100, the cluster 102 can include any number of nodes 106-108.

The cluster 102 can receive instructions from a tenant client 110 at the cluster manager 112. The instructions can include cluster configurations and workload assignments. The instruction can be received at the cluster manager 112 via a network 114 and the service provider application programming interface (API) 116. The network 114 can be any appropriate network such as the internet. The cluster manager 112 can include a mapping of resources to identities in some embodiments. The cluster manager may compare a request against one or more permissions to determine if the requesting tenant has permission to perform the requested operations. A cluster configuration can include the number of nodes, the shape of the nodes (e.g., the computing resources that are assigned to each node), the attached resources for each node, etc.

The cluster manager 112 can communicate with the nodes 106-108 via the control application programming interface (API) 118. The instructions, and any other data for cluster 102 can be stored to control data store 120. The stored data can include any scheduled workloads, the results of any workloads, permissions for the cluster 102, identities, etc. Workloads can be allocated to the nodes 106-108 by the scheduler 122. The state for the nodes, including the shape for each node and any attached resources, can be managed by the node manager 124. The node manager 124 can access an expected state for each node 106-108 via the cluster manager 112 or from the control data store 120. The node manager 124 can monitor the actual state of the nodes 106-108 via the control API 118, and the node manager can change the actual state of the nodes 106-108 if the actual and expected state differ.

The nodes 106-108 and controller 104 can communicate via node agents 126-128. In some embodiments, the communication can occur via network proxies 130-132 in some embodiments. The node agents 126-128 can change the state of each node, attach or remove computing resources from each node, and assign workloads to each node. A workload can be deployed in a group of one or more containers called a pod. Each node 106-108 can have one or more pods 134-136 that are executing on the node simultaneously. A pod 134-136 can correspond to one or more workloads that are scheduled to be executed on the same computing device in a shared context. The context can include common namespaces, control groups, and computing resources for the one or more workloads within the pod.

The cluster manager 112 may receive an instruction from tenant client 110. The instruction can be to attach a computing resource to a node 106-108 of the cluster 102. The instruction may specify an identity for the instruction, and the identity can include a cluster identity or a workload identity. In response to the instruction, the cluster manager 112 may send the instruction, with the identity, to resource manager 138 of the service provider (e.g., via service provider API 116). The resource manager 138 may query the access manager 140 to determine if the identity from the instruction has permission to perform the operations associated with the instruction. If permission is granted, the resource manager 138 can provide the node with access to the resource identified in the instruction.

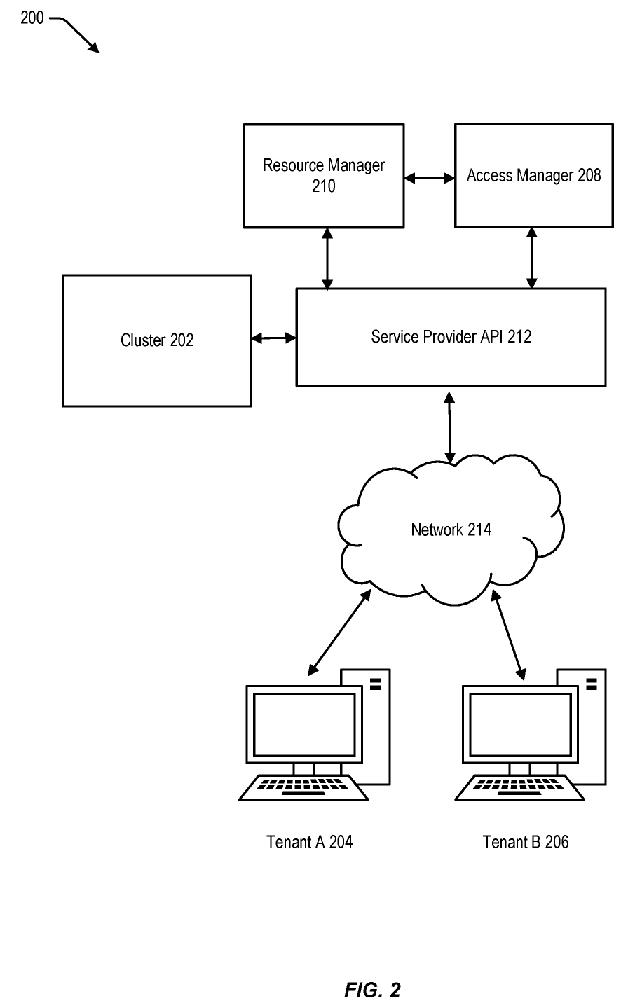

FIG. 2 shows a simplified diagram 200 of a technique for providing a resource to a cluster according to at least one embodiment. Cluster 202 is a multi-tenant cluster that is shared by at least two tenants (e.g., tenant A 204 and tenant B 206). In diagram 200, the resource is a storage volume or a network interface that can be attached to a node in the cluster 202. Attaching the storage volume to a node can mean that the node can remotely access the storage volume as if the volume was local storage that is available to the node.

Tenant A 204 may control permission to access the resource through instructions to access manager 208. For example, tenant A 204 may grant or retract permission to access the resource to one or more identities. The identities can include a cluster identity and one or more workload identities. The cluster identity may be shared by all tenants who have access to a particular cluster (e.g., tenant A 204 and tenant B 206) and a workload identity may be particular to a specific tenant (e.g., tenant A 204 or tenant B 206). Tenant A 204 may instruct access manager 208 to associate a resource with one or more identities. The access manager 208 may determine whether tenant A 204 is authorized to change the permissions for the resource and the one or more identities. The access manager 208 may use these associations to determine whether to grant or deny requests to perform operations with respect to the resource.

Resource manager 210 may receive requests to perform an action with respect to a resource. For example, tenant A 204 may instruct cluster 202 to attach a storage volume to a pod of cluster 202 that is to perform an operation on the storage volume’s data. After receiving the request from tenant A 204, the cluster 202 can forward the request to resource manager 210. Resource manager 210 can control access to the resource, and the request may specify an identity for the request. The resource manager 210 may query the access manager 208 to determine whether the specified identity has permission to perform operations with respect to the resource. In this case, the identity is a workload identity with permission to perform action with respect to the resource, and the access manager 208 grants permission to the resource manager 210 that allows the manager to attach the resource to a pod in cluster 202.

Tenant B 206 may have permission to access cluster 202, but tenant B may not have permission with respect to the workload identity. Tenant B 206 may instruct cluster 202 to attach the resource to a pod that is to perform operations for a second workload. The request may specify a cluster identity for cluster 202, the same workload identity as tenant A 204, or a different workload identity. The request can be forwarded from the cluster 202 to the resource manager 210, and the resource manager 210 may query the access manager 208 to determine whether the identity has permission to perform the operations.

The access manager 208 may reject the request if the identity is a cluster identity. The cluster identity can be used to perform operations with respect to shared resources of cluster 202. However, tenant A 204 can instruct the access manager 208 to associate the resource with a particular identity. For example, tenant A 204 may have privileged permission with regard to the resource. Accordingly, a request with a cluster identifier may be rejected by the access manager 208 unless tenant A 204 has granted permission for the cluster identity to control the resource.

The access manager 208 may reject the request if the identity does not have permission with regard to the resource. For example, tenant B 206 may have permission to use a particular workload identity for tenant B’s resources. The request may be rejected by the access manager 208 unless tenant A 204 has granted permission for the resource to be controlled by tenant B’s workload identity.

Tenant A 204 and tenant B 206 may communicate with the cluster 202, the access manager 208, and the resource manager 210 via a service provider application programming interface (API) 212. The service provider API 212 may be accessible via network 214. Access manager 208 and resources manager 210 may be implemented as software, as hardware, or as a combination of software and hardware.

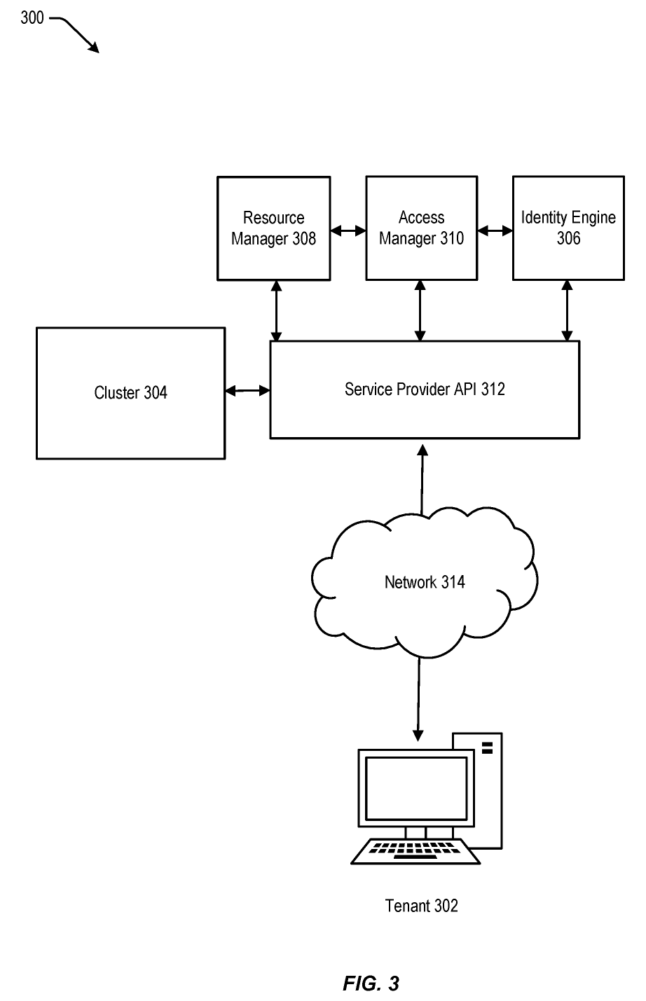

FIG. 3 shows a simplified diagram 300 of an architecture that includes an identity engine according to various embodiments. The request can be a request to perform an operation with respect to a resource that is associated with the cluster 304. In some embodiments, a request from a tenant 302 can be received at a cluster 304. The request may not include an identity, or the request may include a flag that causes the cluster to request an identity from an identity engine 306. The identity engine 306, the resource manager 308, and the access manager 310, may be implemented in hardware, in software, or a combination of software and hardware.

The request can be forwarded from the cluster 304 to the identity engine 306. The identity engine 306 can assign an identity to the request. The request may be forwarded with information about the request including the type of operation that is requested, the tenant that generated the request (E.g., tenant 302), a workload identity, and a network identity. The identity engine 306 can compare the information about the request against one or more rules to determine an identity for the request. The identity engine 306 can return the request to the cluster 304 and the cluster can forward the request, with the returned identity, to the resource manager 308.

The resource manager 308 can query an access manager 310 to determine whether there is permission to grant the request. For example, resource manager 308 may receive requests to perform an action with respect to a resource. Resource manager 308 can control access to the resource, and the request may specify the identity that was returned by the identity engine 306. The resource manager 308 may query the access manager 310 to determine whether the specified identity has permission to perform operations with respect to the resource. The access manager 310 can include a mapping of resources to identities, or the access manager can forward information that is received at the access manager 310 to the identity engine 306. In some embodiments, the tenant 302 can configure permissions for resources through instructions to the access manager 310. These instructions can include a identifier, and the identifier may be obtained from the identity manger 306.

In some embodiments, the identity engine 306 may be used to verify whether the tenant 302 has permission to perform the operations in the request. For example, the request may include an identity and information that corresponds to the request. The identity engine 306 can use the information in the request to determine an identity for the request and the determined identity can be compared against the identity from the request. The request may be denied by the access manager 310 if the determined identity from the identity engine 306 and the identity from the request disagree, but the request may be granted if the two identities agree. The request may be denied, even if the identities agree, if the identity is not associated with permission to perform the requested the operation with respect to the resource. In some embodiments, the request may include a flag that causes the cluster 304 to forward the request to the identity engine 306. The request can be forwarded via service provider API 312, and communication with tenant 302 can occur via a network 314.

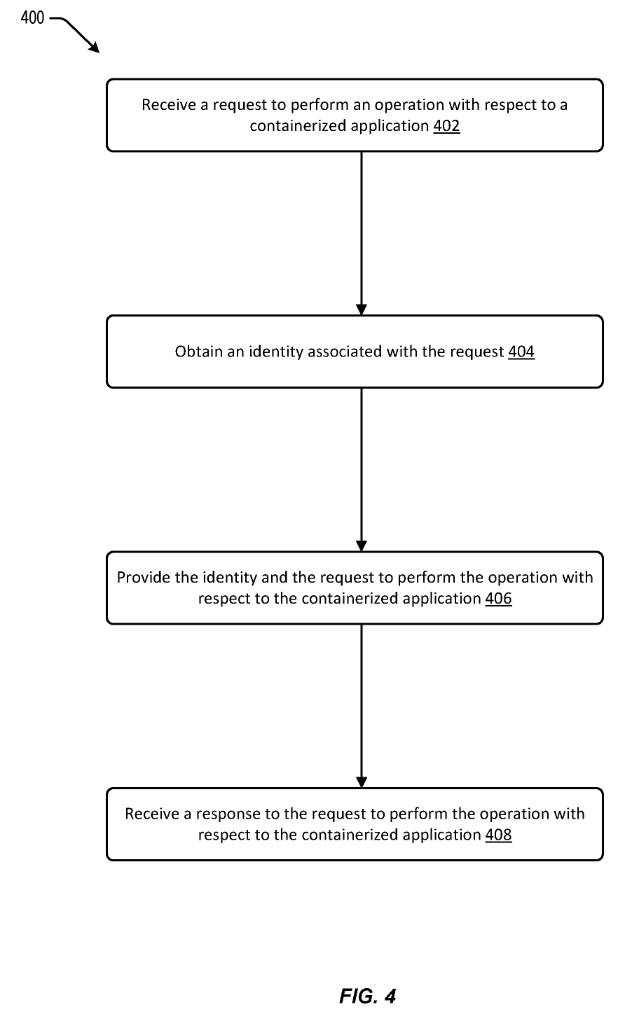

FIG. 4 is a block diagram illustrating an example method 400 for determining resource permissions, in accordance with at least one embodiment. A non-transitory computer-readable storage medium may store computer-executable instructions that, when executed by at least one processor, cause at least one computer to perform instructions comprising the operations of the method 400. It should be appreciated that the operations of the method 400 may be performed in any suitable order, not necessarily the order depicted in FIG. 4. Further, the method 400 may include additional, or fewer operations than those depicted in FIG. 4. Embodiments may include devices, computer-readable non-transitory mediums, systems, and computer-program products that correspond to method 400.

At block 402, a request to perform an operation with respect to a containerized application that is executing on one or more second computing device of the cloud computing system. The request can be received at a service provider computing device of a cloud computing system. The request can be received from a tenant. The service provider computing device can be a controller (e.g., controller 104) and the request can be received via a tenant client device (e.g., tenant client 110, tenant A 204, tenant B 206, tenant 302). The containerized application can a pod such as pods 134-136, and the one or more second computing devices can be nodes within a cluster (e.g., nodes 106-108).

At block 404, an identity associated with the request can be obtained. In some embodiments, the identity can be obtained from the payload of the request by the service provider computing device of the cloud computing system. For example, the payload of the request may include information identifying an identity for the request. In some embodiments, the payload of the request may include a flag that specifies an identity, and the service provider computing device can assign an identity to the request based on the flag. For example, a first value of the flag can specify that a cluster identifier should be assigned to the request and a second value of the flag can specify that a workload identifier should be assigned to the request. An identity can be an alphanumeric identifier in some embodiments.

In some embodiments, the service provider computing device may obtain the request from another cloud computing device of the cloud computing system. For example, the service provider computing device may provide metadata about the request to an identity engine. The metadata can include information from the payload of the request and information about the request. For example, the metadata can include information identifying one or more of the tenant, the containerized application, the operation with respect to the containerized application, the cluster, and the workloads executing on the cluster. The identity engine can compare the metadata against one or more rules to determine an identity for the request.

At block 406, the identity from 404 can be provided to a resource manager computing device of the cloud computing system. The identity can be provided with the request to perform an operation with respect to the containerized application from 402. The resource manager computing device can be a computing device of the cloud service provider system that controls access to one or more resources. For example, the resource manager computing device can attach or detach a storage volume from the one or more second computing devices. The resource manager computing device may create a load balancer in some embodiments. The resource manager computing device can be controller 104, resource manager 138, resource manager 210, or resource manager 308 in various embodiments.

At block 408, a response to the request to perform the operation with respect to the containerized application can be received. The response can indicate whether the resource manager is permitted to perform the operation with respect to the containerized application. The response can indicate whether the resource manager computing device is permitted to perform the operation with respect to the containerized application.

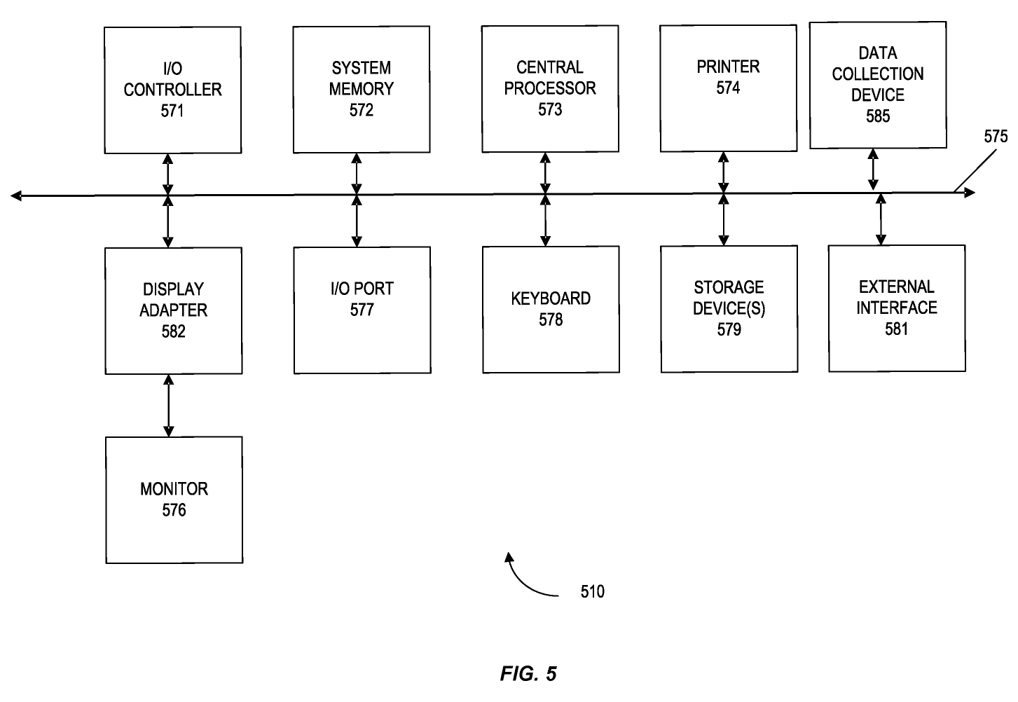

Any of the computer systems mentioned herein may utilize any suitable number of subsystems. Examples of such subsystems are shown in FIG. 5 in computer system 510. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 5 are interconnected via a system bus 575. Additional subsystems such as a printer 574, keyboard 578, storage device(s) 579, monitor 576 (e.g., a display screen, such as an LED), which is coupled to display adapter 582, and others are shown. Peripherals and input/output (I/O) devices, which couple to I/O controller 571, can be connected to the computer system by any number of means known in the art such as input/output (I/O) port 577 (e.g., USB, FireWire^{®}). For example, I/O port 577 or external interface 581 (e.g. Ethernet, Wi-Fi, etc.) can be used to connect computer system 510 to a wide area network such as the Internet, a mouse input device, or a scanner. The interconnection via system bus 575 allows the central processor 573 to communicate with each subsystem and to control the execution of a plurality of instructions from system memory 572 or the storage device(s) 579 (e.g., a fixed disk, such as a hard drive, or optical disk), as well as the exchange of information between subsystems. The system memory 572 and/or the storage device(s) 579 may embody a computer readable medium. Another subsystem is a data collection device 585, such as a camera, microphone, accelerometer, and the like. Any of the data mentioned herein can be output from one component to another component and can be output to the user.

A computer system can include a plurality of the same components or subsystems, e.g., connected together by external interface 581, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

Computer programs typically comprise one or more instructions set at various times in various memory devices of a computing device, which, when read and executed by at least one processor, will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

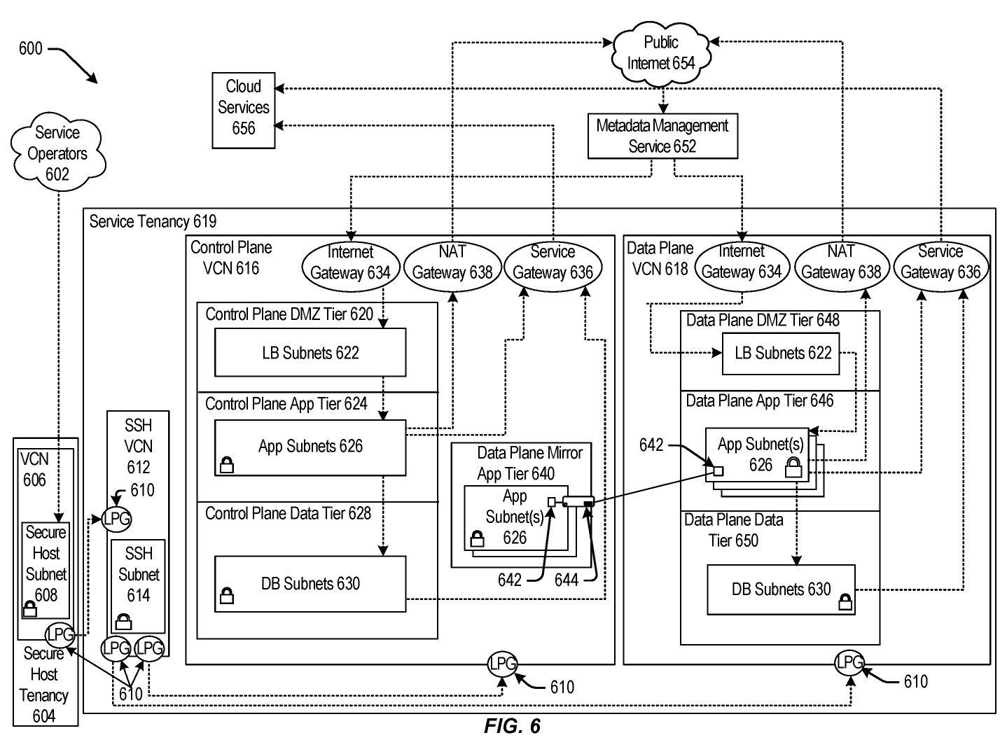

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 9, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users’, or other customers’, resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

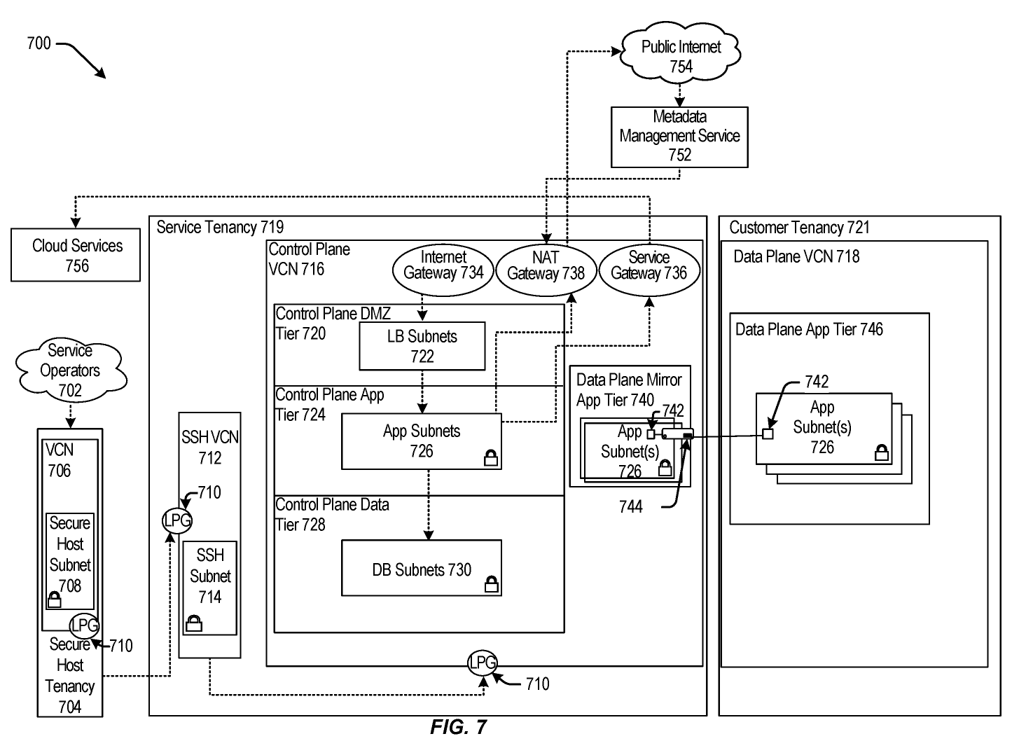

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

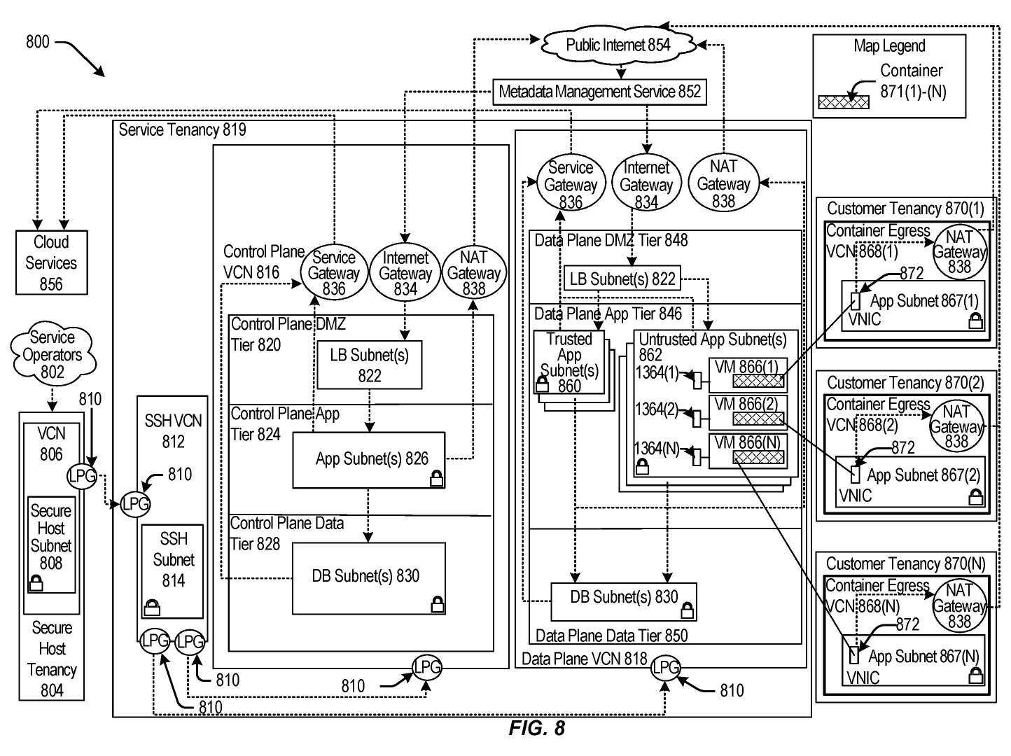

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

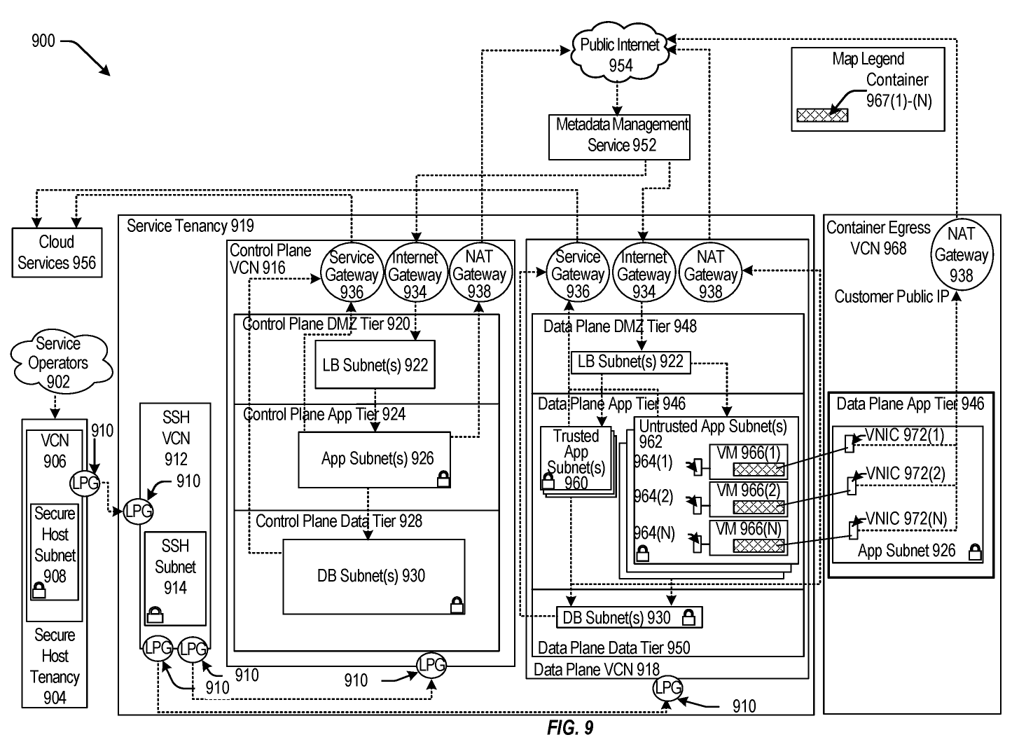

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

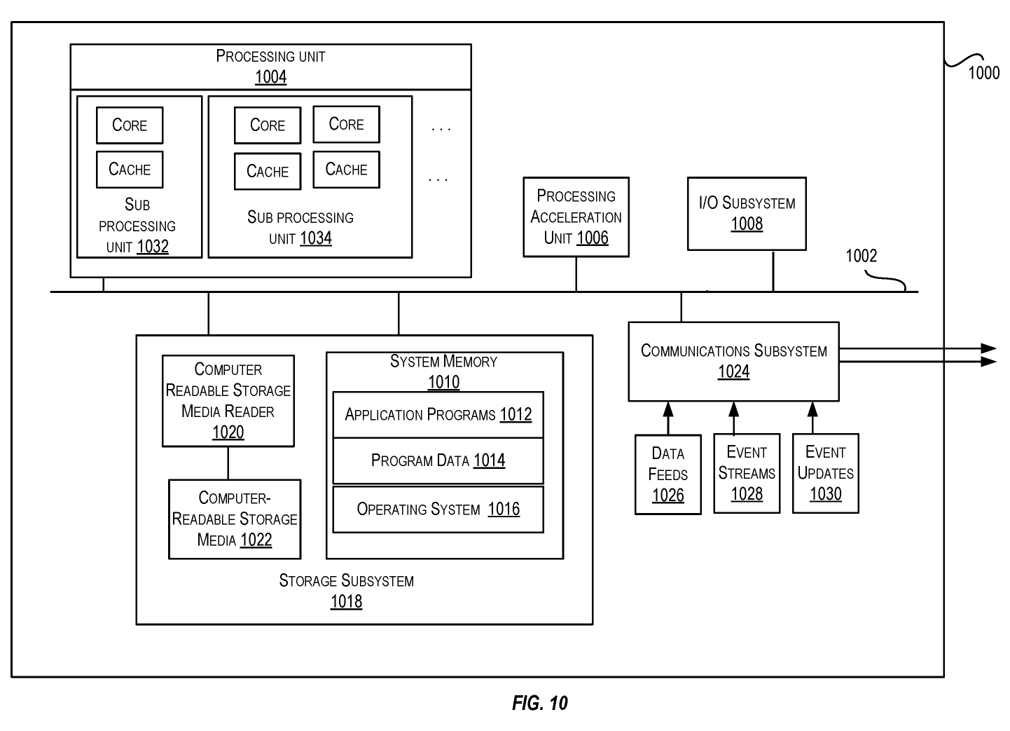

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term "output device" is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 902.11 family standards, or other mobile communication technologies, or any combination thereof)), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, at a service provider computing device of a cloud computing system, a request from a tenant to perform an operation with respect to a containerized application that is executing on one or more second computing devices of the cloud computing system, wherein the containerized application is one of a plurality of containerized applications that are executing on the one or more second computing devices, and wherein workloads of the plurality of containerized applications are assigned to the one or more second computing devices by the service provider computing device;
obtaining, by the service provider computing device, an identity associated with the request;
providing, by the service provider computing device and to a resource manager computing device of the cloud computing system, the identity and the request to perform the operation with respect to the containerized application, wherein the resource manager computing device is configured to query an access management computing device to determine whether the identity is associated with permission to instruct the resource manager computing device to perform the operation with respect to the containerized application; and
receiving, by the service provider computing device and from the resource manager computing device, a response to the request to perform the operation with respect to the containerized application, wherein the response indicates whether the resource manager computing device is permitted to perform the operation with respect to the containerized application.

2. The method of claim 1, wherein obtaining the identity associated with the request comprises:
identifying, by the service provider computing device, metadata of the request, wherein the metadata comprises information identifying one or more of the tenant, the containerized application, the operation with respect to the containerized application, the one or more second computing devices, and the plurality of containerized applications;
providing, by the service provider computing device, the metadata to an identity engine, wherein the identity engine is configured to compare the metadata to one or more permissions of the one or more second computing devices of the cloud computing system, wherein the one or more permissions specify the identity; and
receiving, by the service provider computing device, information identifying the identity from the identity engine.

3. The method of claim 1, wherein obtaining the identity associated with the request comprises:
checking, by the service provider computing device, an application flag of the request; and
assigning, by the service provider computing device, the identity based at least in part on the application flag.

4. The method of claim 1, wherein the tenant is one of a plurality of tenants with permission to perform operations with respect to at least one of the plurality of containerized applications that are executing on the one or more second computing devices.

5. The method of claim 1, further comprising:
instructing, by the service provider computing device, the one or more second computing devices to execute a workload of the containerized application.

6. The method of claim 1, wherein the operation with respect to the containerized application comprises a change to a parameter of the one or more second computing devices.

7. The method of claim 1, wherein parameters of the one or more second computing devices are assigned by the resource manager computing device.

8. A computing device, comprising:
one or more memories; and
one or more processors in communication with the one or more memories and configured to execute instructions stored in the one or more memories to perform operations to:
receive a request from a tenant to perform an operation with respect to a containerized application that is executing on one or more second computing devices of a cloud computing system, wherein the containerized application is one of a plurality of containerized applications that are executing on the one or more second computing devices, and wherein workloads of the plurality of containerized applications are assigned to the one or more second computing devices by the computing device;
obtain an identity associated with the request;
provide, to a resource manager computing device of the cloud computing system, the identity and the request to perform the operation with respect to the containerized application, wherein the resource manager computing device is configured to query an access management computing device to determine whether the identity is associated with permission to instruct the resource manager computing device to perform the operation with respect to the containerized application; and
receive, from the resource manager computing device, a response to the request to perform the operation with respect to the containerized application, wherein the response indicates whether the resource manager computing device is permitted to perform the operation with respect to the containerized application.

9. The computing device of claim 8, wherein obtaining the identity associated with the request comprises operations to:
identify metadata of the request, wherein the metadata comprises information identifying one or more of the tenant, the containerized application, the operation with respect to the containerized application, the one or more second computing devices, and the plurality of containerized applications;
provide the metadata to an identity engine, wherein the identity engine is configured to compare the metadata to one or more permissions of the one or more second computing devices of the cloud computing system, wherein the one or more permissions specify the identity; and
receive information identifying the identity from the identity engine.

10. The computing device of claim 8, wherein obtaining the identity associated with the request comprises operations to:
check an application flag of the request; and
assign the identity based at least in part on the application flag.

11. The computing device of claim 8, wherein the tenant is one of a plurality of tenants with permission to perform operations with respect to at least one of the plurality of containerized applications that are executing on the one or more second computing devices.

12. The computing device of claim 8, further comprising operations to:
instruct the one or more second computing devices to execute a workload of the containerized application.

13. The computing device of claim 8, wherein the operation with respect to the containerized application comprises a change to a parameter of the one or more second computing devices.

14. The computing device of claim 8, wherein parameters of the one or more second computing devices are assigned by the resource manager computing device.

15. A non-transitory computer-readable medium storing a plurality of instructions that, when executed by one or more processors of a computing device, cause the one or more processors to perform operations to:
receive a request from a tenant to perform an operation with respect to a containerized application that is executing on one or more second computing devices of a cloud computing system, wherein the containerized application is one of a plurality of containerized applications that are executing on the one or more second computing devices, and wherein workloads of the plurality of containerized applications are assigned to the one or more second computing devices by the computing device;
obtain an identity associated with the request;
provide, to a resource manager computing device of the cloud computing system, the identity and the request to perform the operation with respect to the containerized application, wherein the resource manager computing device is configured to query an access management computing device to determine whether the identity is associated with permission to instruct the resource manager computing device to perform the operation with respect to the containerized application; and
receive, from the resource manager computing device, a response to the request to perform the operation with respect to the containerized application, wherein the response indicates whether the resource manager computing device is permitted to perform the operation with respect to the containerized application.

16. The non-transitory computer-readable medium of claim 15, wherein obtaining the identity associated with the request comprises operations to:
identify metadata of the request, wherein the metadata comprises information identifying one or more of the tenant, the containerized application, the operation with respect to the containerized application, the one or more second computing devices, and the plurality of containerized applications;
provide the metadata to an identity engine, wherein the identity engine is configured to compare the metadata to one or more permissions of the one or more second computing devices of the cloud computing system, wherein the one or more permissions specify the identity; and
receive information identifying the identity from the identity engine.

17. The non-transitory computer-readable medium of claim 15, wherein obtaining the identity associated with the request comprises operations to:
check an application flag of the request; and
assign the identity based at least in part on the application flag.

18. The non-transitory computer-readable medium of claim 15, wherein the tenant is one of a plurality of tenants with permission to perform operations with respect to at least one of the plurality of containerized applications that are executing on the one or more second computing devices.

19. The non-transitory computer-readable medium of claim 15, further comprising operations to:
instruct the one or more second computing devices to execute a workload of the containerized application.

20. The non-transitory computer-readable medium of claim 15, wherein the operation with respect to the containerized application comprises a change to a parameter of the one or more second computing devices.
